(19) United States
(12) Patent Application Publication
(10) Pub. No.: US 2002/0196270 A1
(43) Pub. Date: Dec. 26, 2002

(54) Methods and systems for computer instruction using a graphical user interface

(76) Inventor: Thomas M. Sirhall, Littleton, CO (US)

Correspondence Address: LAHIVE & COCKFIELD, 28 STATE STREET, BOSTON, MA, 02109, US

(21) Appl. No.: 09/825,536

(22) Filed: Apr. 2, 2001

(51) Int. Cl. G09G 5/00

(52) U.S. Cl. 345/733

(57) ABSTRACT

A method and system for computer instruction is provided. The method includes displaying a question and list of possible answers with associated boxes to a user. The user can check those boxes that the user believes correspond to the correct answer or answers to the question.

### FIELD OF THE INVENTION

The invention relates generally to software and more particularly to software suitable for displaying a series of statements or questions requiring answers in a first section, and a check-icon list of possible answers in a second section.

### BACKGROUND OF THE INVENTION

Some universities and private corporations have created novel educational methods, in contrast to the classic classroom approach at a centralized location, to promote educational opportunities. These methods include distance-learning centers placed in remote locations from a university or company, where students can go to view electronically a class. Another similar approach is to place these educational opportunities online within a computer environment. The online educational courses may be realized as software installed on a stand-alone personal computer, or as software on a network (e.g., a local area network, or the Internet) for access by multiple computers and systems.

Such online courses offer many benefits, including the ability of a student to participate in a course in a more comfortable setting at the student's own pace and convenience. In addition, the top educators in their respective fields can reach and disseminate educational material to many more students than would be possible in a traditional educational institution.

### SUMMARY OF THE INVENTION

The need therefore exists for offering online educational courses. Part of the course involves testing students on subjects covered during the course. One known method of testing in a traditional classroom environment is a multiple-choice exam where students must select correct responses to a question by choosing from among several possible answers. The existing demand for online educational courses could benefit from the ability to implement such a testing structure online.

A check-icon software tool, for use with an online network educational course, can be used to test the knowledge of students enrolled in an online network educational course. A “check-icon list” refers to a list of possible answers with associated icons. The icon can be any convenient shape or graphic, such as a box or circle, and the icon can be associated with a question, for example, by being proximal thereto. The student can select a particular icon associated the answer the student believes is correct. For example, after the question has been displayed, the user can click a specific box with a mouse pointer that the student believes is associated with the correct answer to the question. More than one answer can be chosen, and there may be more than one correct answer. Besides clicking a button with a mouse pointer, other alternative forms may be utilized, such as typing a command on a keyboard, and voicing a command in conjunction with a voice recognition system.

The check-icon application utilizes a graphical user interface (GUI) to communicate with a user. The GUI provides a straightforward and efficient mechanism for generating a software-based educational course exam for an online environment. The GUI manages the display of the questions posed to the student or user, and a check-icon list of possible answers. The GUI enables the student to click an icon associated with a particular answer that the student believes is correct. Once the student has completed one or more questions, the student can instruct the software to check the answers selected, and determine if the question was answered correctly. The score of the student can be stored in computer memory as a source for evaluating the student's performance in the course.

The software tool, in accordance with one example embodiment of the present invention, is created utilizing the Java programming language. Java is a trademark or registered trademark of Sun Microsystems, Inc. in the United States and in other countries. However, any number of suitable programming languages can form the foundation for the software tool.

The software tool, in accordance with further aspects of the present invention, receives data in the form of information relating to the educational course. The information can include the questions to ask the student, and contact information should the student need to obtain some help. A user or third party submits the information in HTML format, or in an input file for the Java code, in accordance with principles of the present invention. The Java input file can include parameters for the background color of the user interface, the correct answers, possible answers that are incorrect, the number of correct answers, and the total number of possible answers. In addition, a message can be included in the input file indicating that at least one response is incorrect, or that all the responses are correct. Once the third party enters the required information, the software tool proceeds to set up the online exam, e.g., according to a predetermined combination of steps.

The software can identify a Jarer class to create a jar file, according to one aspect of the present invention. A “Jarer class” is a class within JAVA that is utilized in creating jar files, which are compressed versions of JAVA files, suitable for transporting over a network, such as the Internet.

In particular, a method for testing a user online is presented. The method includes receiving a request for a software tool from a client, and forwarding the software tool to the client. The software tool when executed on the client displays a question to the user, displays a list of possible answers to the question in response to an action taken by the user, and allows the user to select at least one answer from the list that the user believes corresponds to a correct answer to the question. When the software tool executes, feedback can be provided to the user to indicate if the at least one answer selected is the correct answer. In addition, when the software tool executes, the user can be disabled from selecting answers if, after a predetermined maximum number of attempts, the user does not select the correct answer or answers.

The software tool can include an applet, wherein the applet reads an input file for indicating the list of possible answers, and the correct answers. The applet may also be referenced in a reference file distinct from the input file. In addition, a portion of the software tool can be executed with a virtual machine on the client.

Also provided is a medium for use with an electronic device holding instructions for performing a method for testing a user online, the method including receiving a request for a software tool from a client, and forwarding the software tool to the client. The software tool when executed on the client displays a question to the user, displays a list of possible answers to the question in response to an action taken by the user, and allows the user to select at least one answer from the list that the user believes corresponds to a correct answer to the question.

The software tool can generate a graphical user interface that provides feedback to the user indicating if the at least one selected answer corresponds to a correct answer. In addition, the graphical user interface can permit a predetermined number of user attempts to select the right answer.

Also described below is a system for use with an online educational course. The system includes a computer-readable medium having instructions to run an applet for displaying a question and a drop-down list of possible answers to a user, wherein the user can select at least one answer from the list that the user believes corresponds to a correct answer to the question. The computer readable medium can include hypertext markup language (HTML) code to reference the applet, and the HTML code can include the question.

The system may further include an input file indicating which of the possible answers is correct, the input file being separate from the HTML code to prevent the user from obtaining the correct answer by looking at the HTML code. The computer-readable medium can be a compact disc, for example.

Also described herein is a computer-readable medium having instructions executable on a virtual machine, such as a Java virtual machine, for displaying a question and a drop-down list of possible answers to a user. The user can select at least one answer from the list that the user believes corresponds to a correct answer to the question.

The computer readable medium can include hypertext markup language (HTML) code to invoke the execution of the instructions on the virtual machine, and the HTML code can include the question. The medium can also include an input file indicating which of the possible answers is correct, the input file being separate from the HTML code to prevent the user from obtaining the correct answer by looking at the HTML code.

### BRIEF DESCRIPTION OF THE DRAWINGS

The aforementioned features and advantages, and other features and aspects of the present invention, will become better understood with regard to the following description and accompanying drawings, wherein:

FIG. 1 is schematic of a server and a client for testing a user according to one aspect of the present invention.

FIG. 2 is an input file containing parameters according to one aspect of the present invention.

FIG. 3 is a graphical user interface according to one aspect of the present invention.

FIG. 4 is a graphical user interface according to one aspect of the present invention.

FIG. 5 is a flow chart indicating steps for testing a user according to one aspect of the present invention.

FIG. 6 is a flow chart indicating steps for testing a user according to one aspect of the present invention.

### DETAILED DESCRIPTION OF THE INVENTION

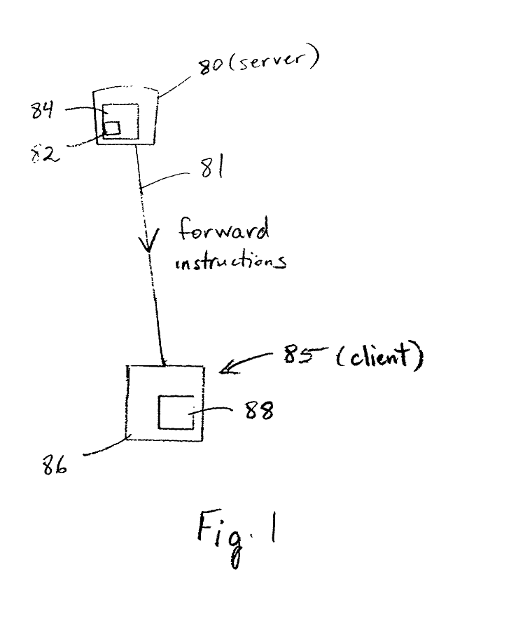

FIGS. 1 through 6, wherein like parts are designated by like reference numerals throughout, illustrate an example embodiment of a software application suitable for interacting with a use r or third party to test that user on information presented in an online educational course. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, language, interface, or type of elements or materials utilized, in a manner still in keeping with the spirit and scope of the present invention.

The present invention generally relates to online educational courses. Such courses utilize various examination methods to test students. Included in these methods are tests that can be conducted online that present written questions to the students, and a icon-box list of possible answers. The student clicks the icon (or icons) associated with the answer (or answers) from among a check-icon list that the student believes is correct.

The software of the illustrative embodiment of the present invention provides a mechanism by which a provider of an online network learning center can enable a student to be tested on information presented in an online educational course setting of an online network learning center environment. Through use of the software, the student is presented with a list of statements or questions that have a check-icon list of possible answers. The student can then click on a particular box corresponding to an answer from the list that the student believes is correct. After making a request to check the answer, the software informs the student whether the answer is correct. If the answer is incorrect, the student is invited to try again up to a maximum number of tries, or, in another embodiment, as often as the student wishes.

The third party educational course combines with other educational courses in a learning center on the network. The resulting educational courses all maintain a similar look and feel in accordance with parameters set forth by the provider of the learning center. The software tool makes it possible for the third party submitters to provide exam questions of their own choosing, while still in keeping with the setup or parameters, including look and feel, of the existing learning center.

The present invention can be used with an online educational learning center where educational courses can be taken with the use of a computer. The learning center provides online opportunities for students to enroll in educational courses pertaining to any number of different subject areas and to be tested by multiple choice exams. Exam questions can be provided by the creator and host of the learning center, or can be provided by third parties (e.g., universities or vendors). A third party wishing to submit and create exam questions for the online learning center can access a learning center website, utilizing a browser such as HotJava from Sun Microsystems, Incorporated, or Netscape Navigator from Netscape Communications, Incorporated. The browser utilized, for the purposes of the embodiments illustrated herein, supports the Java language so that the third party can provide exam questions to the on-line learning center. More specifically, in the illustrative embodiment, a Java applet guides the third party through the process of creating exam questions for an on-line course within the on-line learning center structure.

Java is an object oriented language that provides cross platform capability. The Java software architecture is designed to support platforms ranging from personal computers to embedded network devices of the type similar to a Java desktop device. An “applet” is a program designed to be executed from within another application, such as a Web browser equipped with a Java virtual machine.

In the illustrative embodiment, a third party can add an exam question to the on-line web learning center. The third party first navigates to the appropriate web page, or location, on the network hosting the online learning center by, for example, utilizing a mouse pointer. The network can be a local area network, or can be a more global network such as the Internet. The third party initiates the process to add an exam question by, e.g., clicking on a button entitled “add exam question.” The third party is led to a screen requiring the third party to provide a question for student examinations. The third party enters the required information, such as exam questions, and parameters, such as the correct answers, in an input file.

The questions provided by the third party are incorporated in an HTML document. HTML defines the layout and structure of a Web page, using various tags and attributes. The HTML file can include exam questions and can reference a Java applet that presents the questions to the student and checks the answers.

An example of an HTML fragment that includes the exam questions is the following code:

<div align=“center”>
<table width=“98%” border=“0” cellspacing=“0” cellpadding=“1”

bgcolor=“#000000”>

```
  <tr>
  <td>
    <table border=“0” cellspacing=“0” cellpadding=“1”
    width=“100%”>
    <tr>
      <td height=“22”>
```

<table width=“100%” border=“0” cellspacing=“0”
cellpadding=“5”

bgcolor=“#FFFFFF”>

```
  <tr>
    <td width=“17%” valign=“top” bgcolor=“#000000”
```

align=“center”><b><font color=“#FFFFCC”>Question:</font></b></td>

<td width=“83%” bgcolor=“#e4e4e4”>Which of the

statements below are benefits of using Java servlet technology. Check all
that apply and click the check button.</td>

</tr>
</table>

```
    </td>
    </tr>
    <tr bgcolor=“#FFFFFF”>
    <td height=“22”>
```

<table width=“100%” border=“0” cellspacing=“0”
cellpadding=“8”>

<tr><td>&nbsp;</td></tr>

```
  <tr>
  <td>
```

<div align=“center”>

This code includes an exam question, “Which of the statements below are benefits of using Java servlet technology?” Also included in the code is an instruction on how to answer the question, “Check all that apply and click the check button.” The code can be run with the help of a Web browser. The questions can be viewed by any user running the HTML code using a browser by looking at the source code. The answers, however, are included in a separate file and are not generally available to the user.

Referring now to FIG. 1, a system including hardware for implementing the method of an embodiment of the present invention is shown. A software tool includes computer executable instructions 82 stored on a computer-readable medium 84. The medium 84 can include a hard disk, RAM medium, compact disk, or diskette, for example. The medium 84 can reside on a server 80 that can be remote from the user. To execute the software tool, the server 80 can forward the software tool containing the instructions 82 to a local computer or client 85 via, for example, a network line 81. The software tool can then be executed on a local processor 86 of the client 85 with the help of a virtual machine 88. A graphical user interface is generated by the software tool for displaying a question and a check-icon list of possible answers. The interface allows the user to select or check the icon, such as a box, associated with the answer, from the list of possible answers, that the user believes is correct. If the user believes more than one answer is correct, then more than one icon may be checked.

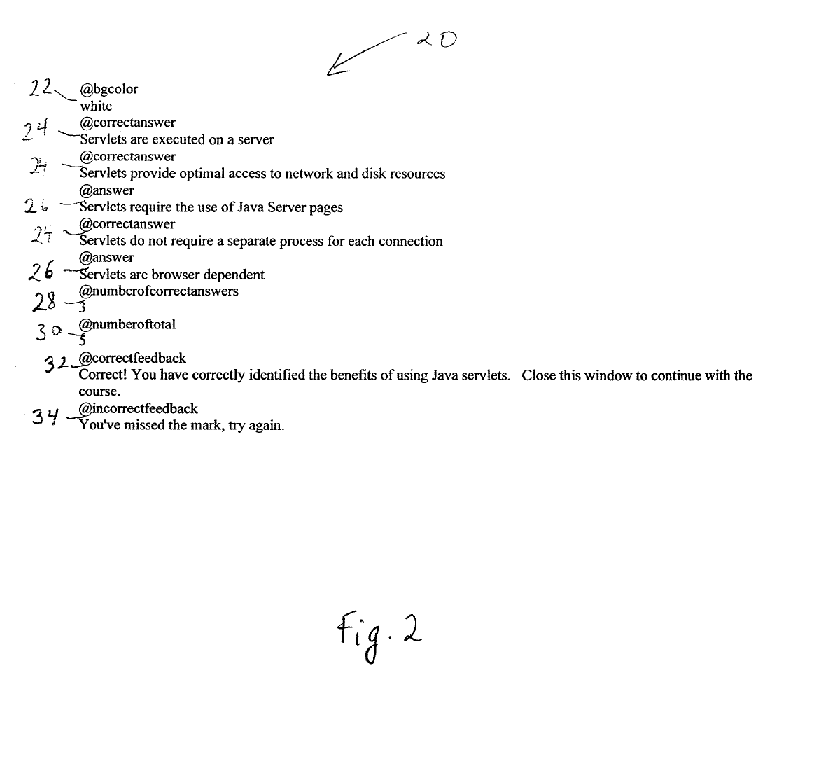

Referring to FIG. 2, an example of a Java input file 20, is presented that can be processed by Java applet code to form an online question for the student in accordance with principles of the present invention. This input file 20 is provided by a party to add a question to an online educational course, and contains numerous parameters. The Java input file includes parameter 22 to set the background color of the user interface. In one embodiment, the default is white. Parameters 24 provide the correct answers. The Java code interprets these answers with the correct ones. There may be one or more correct answer. Parameters 26 provide possible answers that are incorrect. The Java code interprets these parameters as incorrect answers. Parameter 28 provides the number of correct answers, and parameter 30 provides the total number of possible answers. Parameter 32 provides a message for the user indicating that all the responses are correct. Parameter 32 represents the feedback given to the user once the user selects all the correct check-boxes. Parameter 34 provides a message for the user indicating that at least one response is incorrect. Parameter 34 represents the feedback given to the user if at least one answer is wrong. This input file 20 is processed by the applet to add the question to the online educational course.

In another embodiment of the present invention, other parameters can be included. For example, a parameter indicating how many times the student may attempt to answer the question can be provided. After such a number of maximum attempts, MaxAttempts, the correct answers may be divulged to the student. For example, if the student has selected the wrong answers MaxAttempts times, the correct answer can then be displayed to the student. At such time, the student might be prevented from trying to provide further answers to the question, and the last score obtained by the student may be the final score registered for that test question. Instead, the student may be prompted to reset the question to begin anew answering the question.

In general, an exam may include several questions. Each question may have a different MaxAttempts parameter associated therewith. For example, an exam may include two questions, the first of which may be deemed by the administrator to be easier than the second. In such case, the MaxAttempts parameter may be set to be smaller for the first question than the second question. Doing so would give the student more attempts at obtaining the right answer to the second, more difficult question than to the first, easier question.

The server provides a Web page to the client device. The Web page, such as an HTML or XML file, contains the applet described above for facilitating the addition of a question to an online educational course. The Web browser at the client device receives the Web page, interprets the HTML or XML file and renders the Web page on a display device at the client device. The applet may execute on a Java virtual machine provided, for example, by the Web browser. A suitable HTML fragment for the Web page for encoding the applet is:

```
  <applet archive=“. ./. ./. ./STUDENTexam.jar”
  code=“CheckBoxApplet”
```

width=“455” height=“250”>

<param name=“file” value=“checkbox.def”>

```
    <param name=“TBTServletBase” value=“.”>
    <param name=“TBTDocumentBase” value=“”>
```

</applet>

The applet is named “CheckBoxApplet” and it is included in a Java archive file named STUDENTexam.jar.Input parameters are set with the help of the input file 20 such as checkbox.def. The CheckBoxApplet uses the input file 20 to load. The checkbox.def input file 20 is passed in to the applet as a parameter, and subsequently processed by the applet file. TBTServletBase and TBTDocumentBase are used to specify the server and directory that contains the jar file, which contains the applet, and the checkbox.def input file 20.

There are at least two modes that can be used to run the checkbox application of the present invention. In the stand-alone mode the application is stored on the user's local machine. In the server mode, the application is stored on a remote machine. In the stand-alone mode, there is no need to provide a TBTServletBase name because there is no ambiguity as to the server that contains the application. On the other hand, when running on the server mode, the TBTServletBase name indicates on which server the application is stored.

One advantage to providing the answers to the exam question in a separate file, instead of the HTML source file that references the Java applet, is that a user cannot cheat by looking for the answers to a question in the source file, which is usually freely readable. Second, the Java applet requires the correct answer, to check whether or not a student's reply is accurate, but does not require the question. Thus, it is convenient to utilize a separate file as input to the Java applet that contains answers, but no questions. The input file 20 can be altered, and subsequently used by the Java applet, without having to recompile or rejar the applet. Thus, the use of an input file facilitates the introduction of new questions, and the correction of errors. For example, after running the applet it may become evident that there is an error, such as a misspelled word in a message provided to the student. The misspelled word can be modified directly in the input file 20, and the Java code run again, without having to recompile and/or rejar the applet.

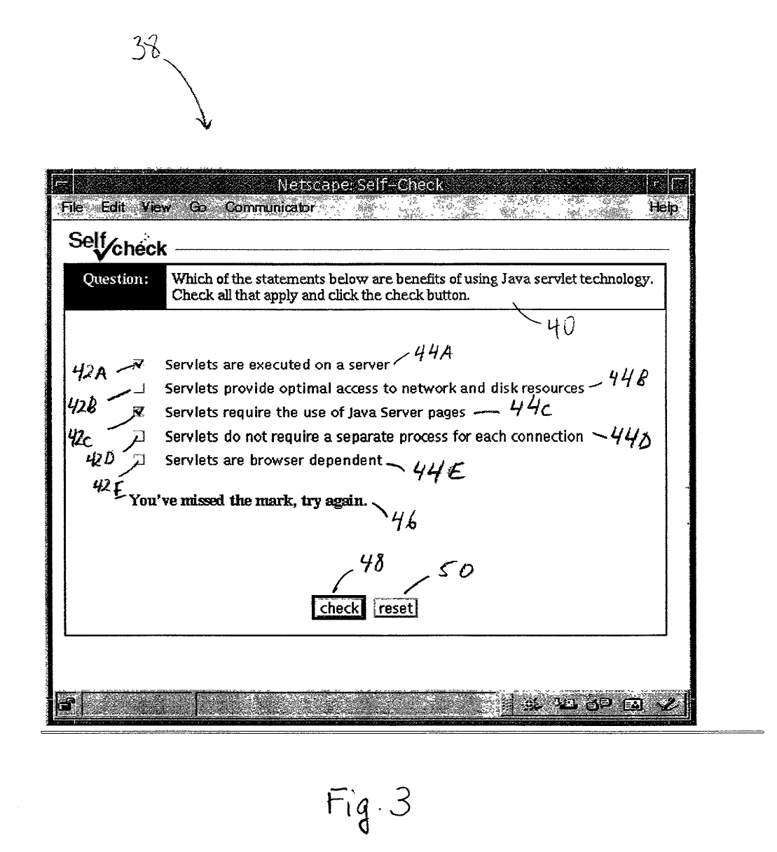

Referring to FIG. 3, a graphical user interface 38 produced by running the check-icon applet is shown. Item 40 is a question posed to the student taking an exam. Five possible answers 44A-44E are shown. Beside each of the five possible answers 44A-44E is a corresponding box 42A-42E. In other embodiments, other convenient shapes or graphics, such as a circle, can be used instead of a box. In FIG. 2, boxes 42A and 42C have been checked by the student. After checking the boxes, the student can click the “check” button 48 with a mouse pointer to obtain some feedback. In response, the Java applet provides a message 46. In this case, the student has not checked off all the correct answers, and/or the possible answer 44A or possible answer 42C checked off by the student is wrong. The student is informed that he has erred, “You've missed the mark” and invited to “try again.” If the reset button 50 is clicked, the checks disappear and the student can start anew to check off answers. Alternatively, the student can click box 42A or 42C to remove the check from this box. i.e., when a box that is already checked off is clicked, the check is eliminated from that box. The student may also check off some of the unchecked boxes 42B, 42D, and/or 42E. In the input file 20 can be included a parameter, MaxAttempts, that dictates the maximum number of tries a student is allowed to obtain the correct answer. In one embodiment, the clicking the reset button would have no bearing on the maximum number of tries the student is allowed.

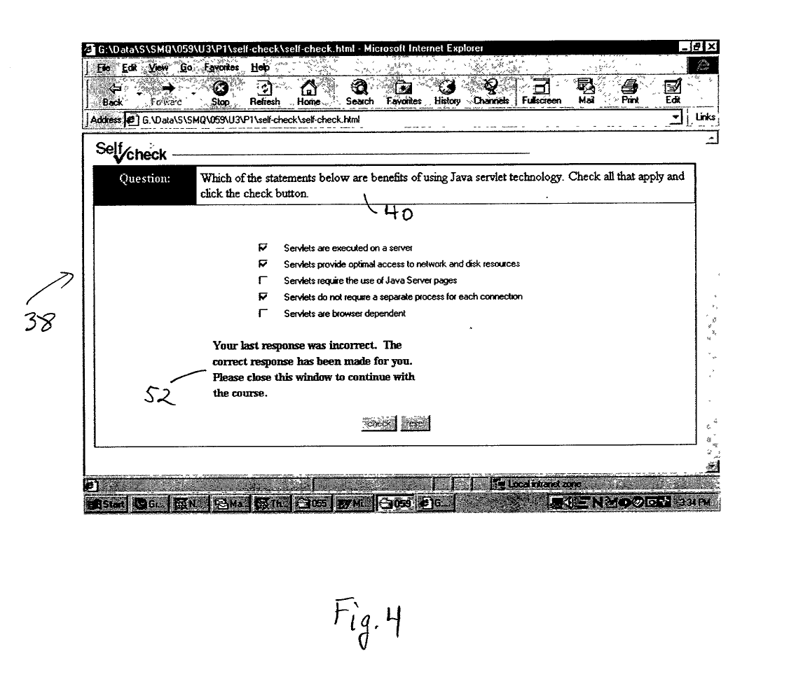

Referring to FIG. 4, a graphical user interface 38 produced by running the drop-down applet is shown. The student has made MaxAttempts attempts, and is not permitted to make any more attempts. A message 52 is presented to the student that informs him that “Your last response was incorrect,” and that the correct answer has been provided, “the correct response has been made for you.” The student is urged to “Please close this window to continue with the course.”

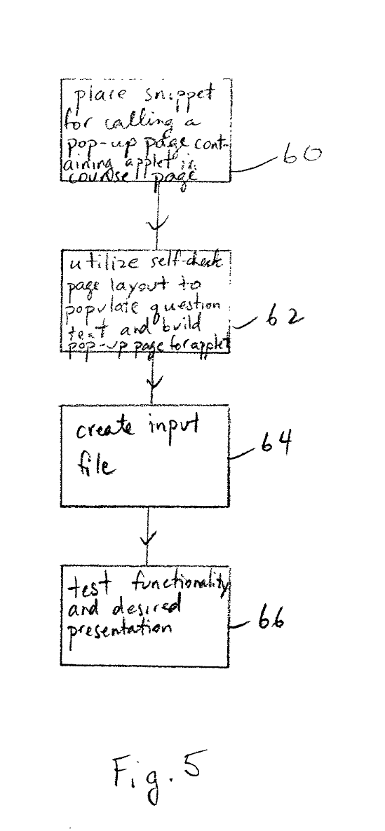

Referring to FIG. 5, a flow chart is shown indicating the steps for including a drop-down application as part of a GUI online course. In step 60, a snippet for calling a pop-up page containing the applet is placed in a desired course page. For example, the following snippet can be included in the desired course page to call the pop-up page containing the applet:

<a href=“HOTTEXT?DialogURL=self-check/self-check.html&DialogWidth=640&DialogHeight=480&DialogTitle=Self-Check&pgtype=framehottext”><img alt=self-check border=0

src=“content:/images/self-check.gif”></a>.

Such a pop-up page can be launched, for example, from a Web page corresponding to the end of an online course. A student can be prompted to click a self-check button, produced by the preceding snippet, to call the pop-up page containing an examination question.

Next, in step 62, the applet's “self-check” page layout is utilized to populate question text and build the pop-up page for the applet. For example, using the applet's self-check layout, the CheckBoxApplet can be called with the following HTML:

<applet codebase=“<prop servletname>content:/java/”

archive=“SESTBTInteractivity.jar”code=“CheckBoxApplet”width=“500”height=“450”>

<param name=“file”value=“checkbox.def”>

<param name=“TBTServletBase”value=“<prop servletname>”>

<param name=“TBTDocumentBase ”value=“<subst

contentPageDocBase>”></applet>.

Next, in step 64, the checkbox.def input file 20 is created with the desired applet tags, as described above. Subsequently, in step 66, the functionality and desired presentation can be tested within the learning center.

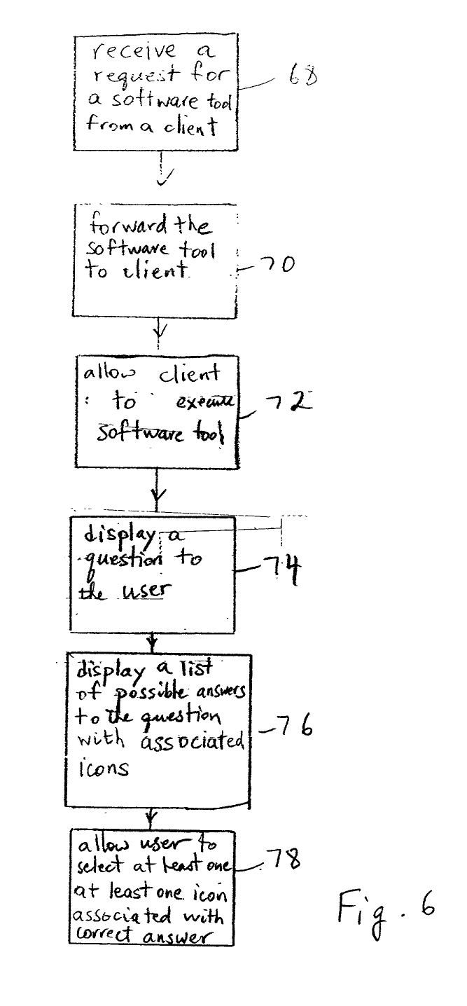

Referring to FIG. 6, a flowchart for testing a user online is presented. In step 68, a request from the client 85 is received by the server 80 for a software tool, which can generate a question and drop-down list of possible answers, as described above. In step 70, the software tool is forwarded to the client. In step 72, the local processor or client 85 of the user executes the software tool. In step 74, a question is displayed to the user. In step 76, a drop-down list of possible answers is displayed to the user in response to an action taken by the user, such as pointing and clicking with a mouse. Subsequently, in step 78, at least one answer that the user believes corresponds to a correct answer to the question is selected by the user.

The display device utilized by the student to read and answer questions can include, for example, personal digital assistants, cell phones, Internet appliances, and desktop and laptop computer monitors.

Although many of the foregoing examples have highlighted the use of Java in the present invention, other computer languages executed by virtual machines may be utilized for this purpose. As known to those of ordinary skill in the art, a virtual machine is an abstract computing machine having an instruction set and being capable of manipulating various memory areas at run time. A well-known virtual machine is the P-Code machine of UCSD Pascal, and the Java virtual machine. The Java virtual machine does not assume any particular implementation technology, host hardware, or host operating system. It is not necessarily interpreted, and can be implemented by compiling its instruction set to that of a silicon processor. The Java virtual machine may also be implemented in microcode or directly in silicon.

These examples are meant to be illustrative and not limiting. The present invention has been described by way of example, and modifications and variations of the exemplary embodiments will suggest themselves to skilled artisans in this field without departing from the spirit of the invention. Features and characteristics of the above-described embodiments may be used in combination. This description is to be construed as illustrative only and is for the purpose of teaching those skilled in the art the best mode for carrying out the invention. The preferred embodiments are merely illustrative and should not be considered restrictive in any way. Details of the structure may vary substantially without departing from the spirit of the invention, and exclusive use of all modifications that come within the scope of the appended claims is reserved. It is intended that the invention be limited only to the extent required by the appended claims and the applicable rules of law. The scope of the invention is to be measured by the appended claims, rather than the preceding description, and all variations and equivalents that fall within the range of the claims are intended to be embraced therein.

What is claimed is:

1. A method for testing a user online comprising the steps of:
a) receiving a request for a software tool from a client; and
b) forwarding the software tool to the client, wherein said software tool when executed on the client
i) displays a question to the user;
ii) after displaying the question, displays a list of possible answers to the question with associated icons; and
iii) allows the user to select at least one icon that the user believes is associated with a correct answer to the question.

2. The method of claim 1, wherein, when the software tool executes, feedback is provided to the user to indicate if the at least one selected icon is associated with the correct answer.

3. The method of claim 1, wherein, when the software tool executes, the user is disabled from selecting icons if, after a predetermined maximum number of attempts, the user does not select the correct answer or answers.

4. The method of claim 1, wherein, in the steps of receiving and forwarding, the software tool includes an applet.

5. The method of claim 4, wherein the applet reads an input file for indicating the list of possible answers, and the correct answers.

6. The method of claim 5, wherein the applet is referenced in a reference file distinct from the input file.

7. The method of claim 1, wherein, in the step of forwarding, a portion of the software tool is executed with a virtual machine on the client.

8. A medium for use with an electronic device holding instructions for performing a method for testing a user online, the method comprising the steps of:
a) receiving a request for a software tool from a client; and
b) forwarding the software tool to the client, wherein said software tool when executed on the client
i) displays a question to the user;
ii) after displaying the question, displays a list of possible answers to the question with associated icons; and
iii) allows the user to select at least one icon that the user believes is associated with a correct answer to the question.

9. The medium of claim 8, wherein the software tool generates a graphical user interface that provides feedback to the user to indicate if the at least one selected icon is associated with the correct answer.

10. The medium of claim 9, wherein the graphical user interface permits a predetermined number of user attempts to select the right answer.

11. A system for use with an online educational course, the system comprising a computer-readable medium having instructions to run an applet for displaying a question and a check-icon list of possible answers to a user, wherein the user can select at least one icon that is associated with an answer from the list that the user believes corresponds to a correct answer to the question.

12. The system of claim 11, wherein the computer readable medium includes hypertext markup language (HTML) code to reference the applet.

13. The system of claim 12, wherein the HTML code includes the question.

14. The system of claim 13, further comprising an input file indicating which of the possible answers is correct, said input file being separate from the HTML code to prevent the user from obtaining the correct answer by looking at the HTML code.

15. The system of claim 11, wherein the computer-readable medium is a compact disc.

16. A medium having instructions executable on a virtual machine for displaying a question and a check-icon list of possible answers to a user, wherein the user can select at least one icon that is associated with an answer from the list that the user believes corresponds to a correct answer to the question.

17. The medium of claim 16, wherein the virtual machine is a Java virtual machine.

18. The medium of claim 16, wherein the computer readable medium includes hypertext markup language (HTML) code to invoke the execution of the instructions on the virtual machine.

19. The medium of claim 18, wherein the HTML code includes the question.

20. The medium of claim 19, further comprising an input file indicating which of the possible answers is correct, said input file being separate from the HTML code to prevent the user from obtaining the correct answer by looking at the HTML code.
